(19) United States
(12) Patent Application Publication
(10) Pub. No.: US 2007/0115454 A1
(43) Pub. Date: May 24, 2007

(54) Environmental detection system with two spaced-apart emitters and receivers

(75) Inventor: Holger Schanz, Allmendingen (DE)

Correspondence Address: CONTINENTAL TEVES, INC., ONE CONTINENTAL DRIVE, AUBURN HILLLS, MI, 48326-1581, US

(73) Assignee: Continental Teves AG & Co. oHG

(21) Appl. No.: 10/572,115

(22) PCT Filed: Aug. 19, 2004
(86) PCT No.: PCT/DE04/01845

§ 371 Date: Mar. 16, 2006

(30) Foreign Application Priority Data
Sep. 17, 2003 (DE) 103 42 836.4

(51) Int. Cl. G01C 3/08; G01P 3/36

(52) U.S. Cl. 356/4.01; 356/28

(57) ABSTRACT

Disclosed is an environment detection system having two emitters of electromagnetic waves and two correspondingly directed receivers for receiving reflections of the emitted waves. The first emitter and first receiver are directed towards a first target area while the second emitter and second receiver are directed towards a second target area. In order to cover a third target area an optical element is arranged in front of the first emitter to direct at least occasionally a proportion of the waves emitted by the emitter towards the third target area. A second optical element is arranged in front of the second receiver to direct reflections of the waves emitted by the first emitter towards the third target area towards the second receiver. The optical elements may be arranged permanently and only one emitter is active a time so that one receiver covers the third target area without being disturbed. This enables an emitter-receiver pair arranged on the right side of a motor vehicle and one arranged on the left side of the motor vehicle to cover the whole front area in the direction of motion, when both emitter-receiver pairs are arranged in the direction of motion.

### BACKGROUND OF THE INVENTION

The invention relates to an environment detection system consisting of at least two emitters (S1, S2) of electromagnetic waves and two receivers (E1, E2) for receiving reflections of the emitted waves. The first emitter (S1) and an immediately adjacent first receiver (E1) are directed towards a first target area (Z1) and, spaced apart therefrom, while a second emitter (S2) and an adjacent second receiver (E2) are directed towards a second target area (Z2).

In future, such environment detection systems will be particularly employed in motor vehicles for longitudinal control, tracking error warning and tracking, or for taking measures in the event of an imminent crash.

The emitters generate, corresponding to a predetermined dispersion, one illuminated target area each, towards each of which one receiver is directed that detects the reflections from the target area, wherein the emitter and the receiver, as a rule, are arranged immediately adjacent to each other and the target area, dependent on the angle of dispersion, is approximately conical. For covering the complete road, the emitters must comprise an appropriate distance between each other. While the conical target areas meet at great distances from the vehicle if the emitters comprise an appropriate distance to each other, there is an area in the near range that cannot be covered. For covering this area, an additional, third emitter and an appropriately oriented receiver would have to be provided (see FIG. 1).

### SUMMARY OF THE INVENTION

The object of the invention is to provide an alternative environment detection system that enables covering to be as complete as possible. This object is achieved by an environment detection system consisting of at least two emitters of electromagnetic waves and two receivers for receiving reflections of the emitted waves. The first emitter and an immediately adjacent first receiver are directed towards a first target area and, spaced apart therefrom, a second emitter and an adjacent second receiver are directed towards a second target area.

The invention is based on the idea of directing, by employing appropriate optical means, at least a proportion of the waves emitted by an emitter towards the third target area to be covered and detecting reflections occurring in that area by means of the spaced-apart receiver, i.e. coupling the emitters and receivers crosswise in the end.

### BRIEF DESCRIPTION OF THE DRAWINGS

The invention will now be explained in greater detail on the basis of exemplary embodiments and figures.

Brief Description of the Figures:

FIG. 1 Prior-art environment detection system in a motor vehicle;

FIG. 2 Realization of an inventive environment detection system in the first operating phase;

FIG. 3 Environment detection system in the second operating phase.

### DETAILED DESCRIPTION OF THE DRAWINGS

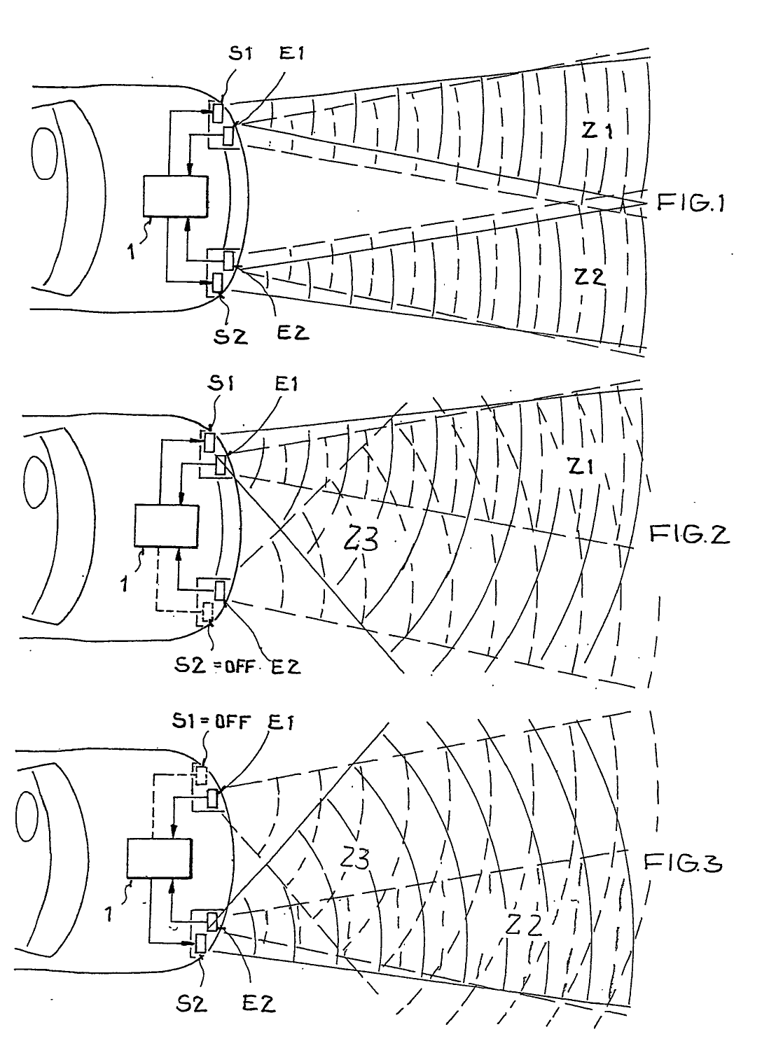

FIG. 1 shows an environment detection system in a motor vehicle that is known to be capable of being used for longitudinal control or pre-crash recognition or other applications in future. It comprises at least two emitters S1, S2 of electromagnetic waves that are arranged on the right and left sides of the vehicle and emit in the direction of motion in this example. Correspondingly, two receivers E1, E2 are provided that receive reflections of the emitted waves, wherein the first emitter S1 and the first receiver E1 are directed towards a first target area Z1, and a second emitter S2 and a second receiver E2 are directed towards a second target area Z2, thereby completely covering the front area in front of the vehicle at least from a certain distance onwards. An uncovered area remains in the near range on account of the conical widening of the target areas in the direction of motion.

Therefore the invention proposes that, as indicated in FIG. 2, at least the first emitter S1 and preferably both emitters S1 and S2 comprise/s optical means that at least occasionally direct at least a proportion of the waves emitted by this emitter S1 towards the third target area Z3 and that at least the second receiver E2 and preferably also the first receiver E1 comprise/s optical means that at least occasionally direct reflections of the waves emitted by the first emitter S1 towards the third target area Z3 towards the second receiver E2. Such optical means can include appropriately adapted lenses, prisms or lenses of the headlight. These optical means can be occasionally arranged in front of the emitters and receivers for illuminating and covering the third target area Z3 so that Z1, Z2 and Z3 are covered in turns.

Preferably however, the optical means are permanently arranged in front of the first emitter S1 and the second receiver E2 and direct in each case only a proportion of the emitted waves towards target area Z3 and from this target area Z3 on to receiver E2, respectively.

During a first operating phase, the first emitter S1 emits, wherein at the same time the first receiver E1 covers the first target area Z1 and the second receiver E2 covers the third target area Z3 while the second emitter S2 is inactive (see FIG. 2).

During a second operating phase according to FIG. 3, the second emitter S2 emits, wherein the second receiver E2 covers the second target area Z2. Of course, the first receiver E1 can cover the third target area Z3 during the second operating phase if preferred. In this case, the third target area is covered twice as often as the first and second target areas but this is desired since the third target area comprises the area immediately in front of the vehicle and covering is particularly time-critical there.

The third target area Z3 at least partially covers a near range situated between the first and second target areas Z1, Z2 but can certainly overlap them.

Timing control of the emitters and receivers and the evaluation of the receiver signals and the assignment of the target areas are carried out in a central evaluation unit 1 that then supplies the processed signals to the corresponding application units.

1-4. (canceled)

5. An environment detection system comprising:
at least two emitters (S1, S2) for emitting electromagnetic waves;
at least two receivers (E1, E2) for receiving reflections of the emitted waves, wherein a first emitter (S1) and an immediately adjacent first receiver (E1) are directed towards a first target area (Z1) and, spaced apart therefrom, a second emitter (S2) and an adjacent second receiver (E2) are directed towards a second target area (Z2);
a first optical element arranged to at least occasionally direct at least a proportion of the emitted wave from the first emitter (S1) towards a third target area (Z3); and
a second optical element arranged to at least occasionally direct reflections of the waves emitted by the first emitter (S1) towards the third target area (Z3) towards the second receiver (E2), wherein the third target area (Z3) at least partially covers a near range situated between the first and second target areas (Z1, Z2).

6. An environment detection system according to claim 5, wherein the first optical element is permanently arranged in front of the first emitter (S1) and second optical element is permanently arrange in front of the second receiver (E2);
during a first operating phase, the first emitter (S1) emits and the first receiver (E1) covers the first target area (Z1) and the second receiver (E2) covers the third target area (Z3) while the second emitter (S2) is inactive; and
during a second operating phase, the second emitter (S2) emits and the second receiver (E2) covers the second target area (Z2).

7. An environment detection system according to claim 6, wherein the system is provided in a motor vehicle.

8. An environment detection system according to claim 6, wherein the optical elements are permanently provided in front of the first and second emitters (S1, S2) and in front of the first and second receivers (E1, E2), the optical elements partially direct each of the emitters and receivers towards the third target area (Z3); and
during a first operating phase, the first emitter (S1) emits and the first receiver (E1) covers the first target area (Z1) and the second receiver (E2) covers the third target area (Z3) while the second emitter (S2) is inactive; and
during a second operating phase, the second emitter (S2) emits and the first receiver (E1) covers the third target area (Z3) and the second receiver (E2) covers the second target area (Z2).

9. An environment detection system according to claim 8, wherein the system is provided in a motor vehicle.

10. An environment detection system according to claim 5, wherein the system is provided in a motor vehicle.
